(19) United States
(12) Patent Application Publication
(10) Pub. No.: US 2024/0078319 A1
(43) Pub. Date: Mar. 7, 2024

(54) EBPF-BASED HOT PATCH ENGINE DEVICE FOR PROTECTING KERNEL VULNERABILITIES, SYSTEM AND METHOD INCLUDING THE SAME

(71) Applicant: Foundation of Soongsil University-Industry Cooperation, Seoul (KR)

(72) Inventors: Souhwan JUNG, Seoul (KR); Thien-Phuc DOAN, Seoul (KR); Songi GWAK, Seoul (KR)

(73) Assignee: Foundation of Soongsil University-Industry Cooperation, Seoul (KR)

(21) Appl. No.: 18/210,396

(22) Filed: Jun. 15, 2023

(30) Foreign Application Priority Data
Sep. 1, 2022 (KR) 10-2022-0110784

(51) Int. Cl. G06F 21/57; G06F 8/656

(52) U.S. Cl. CPC G06F 21/577; G06F 8/656; G06F 2221/034

(57) ABSTRACT

Provided is an eBPF-based hot patch engine device for protecting kernel vulnerabilities. The eBPF-based hot patch engine device comprises a container-aware code generating unit for generating a container-aware code for identifying a target container, to which a hot patch is attached; and a hot patch configuring unit for configuring an eBPF-based hot patch code for attaching a hot patch to the target container based on the container-aware code. Accordingly, it is possible to prevent attacks based on CVEs, which are known vulnerabilities for container systems, by hot patching kernel-related CVEs at runtime without rebooting and freezing.

### CROSS-REFERENCE TO RELATED APPLICATIONS

This application claims the benefit of Korean Application No. 10-2022-0110784, filed Sep. 1, 2022, in the Korean Intellectual Property Office. All disclosures of the document named above are incorporated herein by reference.

### TECHNICAL FIELD

The present invention relates to an eBPF-based hot patch engine device for protecting kernel vulnerabilities, and a system and method including the same, and more particularly, it relates to an eBPF-based hot patch engine device for protecting kernel vulnerabilities capable of patching a new version of a kernel, and a system and method including the same.

### BACKGROUND ART

In computing, a system call is a programming method that requests a service from the kernel of an operating system, in which a computer program is executed, and such a system call is a method that helps a program interact with an operating system.

Accordingly, when a computer program requests a service from an operating system kernel, a system call is called, and the system call, as an application program interface (API), may provide an operating system service to a user program.

Meanwhile, container technology has developed rapidly in recent years and is widely applied to building cloud computing systems such as microservices, edge services, and cloud natives.

In the case of hot patch that immediately patches a new version to the kernel space used by these containers, updating the kernel version to patch the system requires a reboot of the machine, but this can affect availability in a cloud environment, to which a container environment is applied.

Therefore, a hot patch that doesn't require a reboot is needed. However, in the conventional solution for hot patch without rebooting, whenever a patch is needed, the memory of the system is frozen and the patch is applied during the freezing time.

However, since this requires stopping the running system, it is not efficient even if rebooting itself is not executed, so a hot patch that does not require a reboot and does not affect the running system is necessary.

In addition, there is a problem that the update of the new version can make the system unstable. While all services run reliably in older versions of the system, when the system is updated, software conflicts may occur due to the deprecation of kernel functions and the like.

Therefore, hot patches that only affect vulnerable functions of the kernel or vulnerable software that uses kernel functions in the wrong way are needed. In other words, a hot patch is needed that affects only a specific process, that is, a container with a specific vulnerability, not the entire system.

### PRIOR ART

### Patent Reference

Korean Patent Application Publication No. 10-2019-0038065

### DISCLOSURE

### Technical Problem

The present invention was made to solve the above problems, and an object of the present invention is to provide an eBPF-based hot patch engine device for protecting kernel vulnerabilities capable of preventing attacks based on CVE, a known vulnerability for container systems, by hot patching the CVE related to the kernel at runtime without rebooting and freezing the service, and a system and method including the same.

Another object of the present invention is to provide an eBPF-based hot patch engine device for protecting kernel vulnerabilities, in which multiple patches can be independently applied to individual containers or multiple containers rather than the entire container system, and a system and method including the same.

Another object of the present invention is to provide an eBPF-based hot patch engine device for protecting kernel vulnerabilities capable of allowing a host or container system, in which a service run, to properly operate without interfering them by patching using eBPF technology, and a system and method including the same.

### Technical Solution

In order to achieve the above object, according to an embodiment of the present invention, an eBPF-based hot patch engine device for protecting kernel vulnerabilities comprises a container-aware code generating unit for generating a container-aware code for identifying a target container, to which a hot patch is attached; and a hot patch configuring unit for configuring an eBPF-based hot patch code for attaching a hot patch to the target container based on the container-aware code.

And, the hot patch configuring unit configures an eBPF-based hot patch code so that a patching code for CVE (Common Vulnerabilities and Exposures), which is a kernel vulnerability, can be patched to a kernel space used by the target container.

And, the container-aware code generating unit generates the container-aware code based on container information included in a container system, and the container information includes at least one of container ID and container runtime information included in the container system.

And, the container ID includes a name and hash of a corresponding container.

And, the hot patch configuring unit configures the eBPF-based hot patch code by loading a preset hot patch template and inputting information included in the patching code and the container-aware code into the hot patch template.

And, the device further comprises a hot patch control unit for patching the hot patch code to a kernel space used by the target container using a BPF system call and receiving a notification when a vulnerability of the patched hot patch code is triggered.

And, the device allows the hot patch code to be individually patched only in the target container using a corresponding kernel space, and the container system to be executable.

And, the container-aware code includes a mount namespace ID.

To achieve the above object, according to an embodiment of the present invention, an eBPF-based hot patch method in an eBPF-based hot patch engine device for protecting kernel vulnerabilities comprises generating a container-aware code for identifying a target container, to which a hot patch is attached; and configuring an eBPF-based hot patch code for attaching a hot patch to the target container based on the container-aware code.

And, configuring the eBPF-based hot patch code comprises configuring the eBPF-based hot patch code so that a patching code for CVE (Common Vulnerabilities and Exposures), which is a kernel vulnerability, can be patched to a kernel space used by the target container.

And, generating the container-aware code comprises generating the container-aware code based on container information included in a container system, and the container information includes at least one of container ID and container runtime information included in the container system.

And, the container ID includes a name and hash of a corresponding container.

And, configuring the eBPF-based hot patch code comprises configuring the eBPF-based hot patch code by loading a preset hot patch template and inputting information included in the patching code and the container-aware code into the hot patch template.

And, the method further comprises patching the hot patch code to a kernel space used by the target container and receiving a notification when a vulnerability of the patched hot patch code is triggered.

And, the hot patch code is individually patched only in the target container using a corresponding kernel space, and the container system is executable.

And, the container-aware code includes a mount namespace ID.

To achieve the above object, according to an embodiment of the present invention, a container system including at least one container comprises an eBPF-based hot patch engine device for protecting kernel vulnerabilities, wherein the eBPF-based hot patch engine device generates a container-aware code for identifying a target container, to which a hot patch is attached, in the container system, configures an eBPF-based hot patch code based on the container-aware code, and patches the hot patch code to a kernel space used by the target container.

And, the eBPF-based hot patch engine device comprises a container-aware code generating unit for generating a container-aware code for identifying a target container, to which a hot patch is attached; a hot patch configuring unit for configuring an eBPF-based hot patch code for attaching a hot patch to the target container based on the container-aware code; and a hot patch control unit for patching the hot patch code to a kernel space using a BPF system call and receiving a notification when a vulnerability of the patched hot patch code is triggered.

### Advantageous Effects

According to one aspect of the present invention described above, by providing an eBPF-based hot patch engine device for protecting kernel vulnerabilities, and a system and method including the same, attacks based on CVE, a known vulnerability to container systems, can be prevented by hot patching CVE related to the kernel at runtime without rebooting and freezing.

In addition, multiple patches can be applied independently to individual containers or multiple containers, rather than to the entire container system.

In addition, by patching using eBPF technology, it is possible to enable proper operation of the host or container system, in which the service is running, without interfering with them.

### DESCRIPTION OF DRAWINGS

These and/or other aspects will become apparent and more readily appreciated from the following description of the embodiments, taken in conjunction with the accompanying drawings in which:

FIGS. 1 and 2 are diagrams describing an eBPF-based hot patch system for protecting kernel vulnerabilities according to an embodiment of the present invention;

FIGS. 3 and 4 are diagrams describing an eBPF-based hot patch engine device according to an embodiment of the present invention;

FIG. 5 is a diagram describing parameters used in an eBPF-based hot patch engine device according to an embodiment of the present invention;

FIG. 6 is a diagram describing a hot patch template used in an eBPF-based hot patch engine device according to an embodiment of the present invention;

FIG. 7 is a diagram describing an actual patching code used to configure a hot patch code in an eBPF-based hot patch engine device according to an embodiment of the present invention;

FIG. 8 is a diagram describing a process of configuring a hot patch code to solve the CVE of FIG. 7 in an eBPF-based hot patch engine device according to an embodiment of the present invention; and

FIG. 9 is a flowchart of an eBPF-based hot patch method in the eBPF-based hot patch engine device of FIGS. 3 and 4.

### DETAILED DESCRIPTION OF EMBODIMENTS

The detailed description of the present invention which follows refers to the accompanying drawings which illustrate, by way of illustration, specific embodiments in which the present invention may be practiced. These embodiments are described in sufficient detail to enable those skilled in the art to practice the present invention. It should be understood that the various embodiments of the present invention are different from each other but are not necessarily mutually exclusive. For example, specific shapes, structures, and characteristics described herein may be implemented in another embodiment without departing from the spirit and scope of the invention in connection with one embodiment. Additionally, it should be understood that the location or arrangement of individual components within each disclosed embodiment may be changed without departing from the spirit and scope of the invention. Accordingly, the detailed description set forth below is not to be taken in a limiting sense, and the scope of the present invention, if properly described, is limited only by the appended claims, along with all equivalents as claimed by those claims. Like reference numbers in the drawings indicate the same or similar function throughout the various aspects.

According to the present invention, components are defined not by physical division but by functional division, and may be defined by the functions each performs. Each of the components may be implemented as hardware or program codes and processing units that perform respective functions, and the functions of two or more components may be implemented by being included in one component. Therefore, the names given to the components in the following embodiments are not to physically distinguish each component, but to imply the representative function performed by each component, and it should be noted that the technical idea of the present invention is not limited by the names of the components.

Hereinafter, preferred embodiments of the present invention will be described in more detail concerning the drawings.

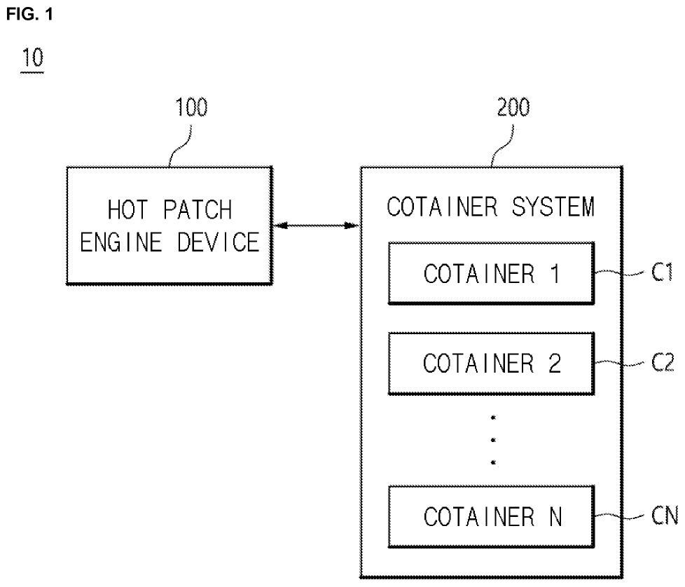

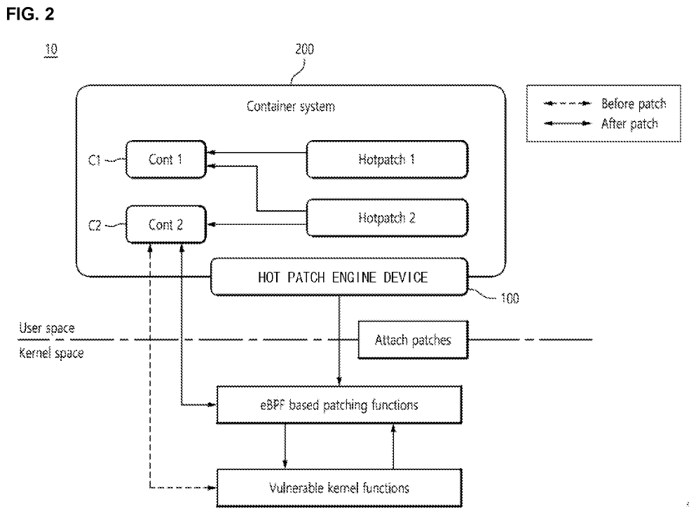

FIGS. 1 and 2 are diagrams for describing an eBPF-based hot patch system for protecting kernel vulnerabilities according to an embodiment of the present invention.

The eBPF-based hot patch system 10 (hereinafter referred to as the system) of the present invention is prepared to build a hot patching system for preventing Linux kernel vulnerabilities. Specifically, the system 10 can configure an eBPF-based hot patch code to take advantage of the eBPF technology that enables hooking and tracking of kernel functions. Also, the system 10 may attach hot patch code to a kernel space.

Referring to FIGS. 1 and 2, the system 10 according to the present invention may comprise a hot patch engine device 100 and a container system 200.

In the system 10, software (application) for performing an eBPF-based hot patch method may be installed and executed. Also, the configurations of the hot patch engine device 100 and the container system 200 may be controlled by software for executing the eBPF-based hot patch method executed in the system 10.

The container system 200 may include at least one container C1, C2, . . . , CN. In addition, the container system 200 can be linked with the hot patch engine device 100 and patching can be supported by the hot patch engine device 100.

The hot patch engine device 100 (hereinafter referred to as the device) is an eBPF-based device for protecting kernel vulnerabilities, and is prepared to manage patches attached to containers and control the patching process.

Also, the device 100 may provide container-awareness by supporting patching for a specific container.

Accordingly, the device 100 according to an embodiment of the present invention may attach and detach a hot patch to a specific container among containers included in the container system 200, that is, to a target container.

More specifically, the device 100 may generate a container-aware code for identifying a target container, to which a hot patch is attached, in the container system 200.

In addition, the device 100 may configure an eBPF-based hot patch code based on the container-aware code.

Also, as shown in FIG. 2, the device 100 may patch a hot patch code to a kernel space used by a target container.

In particular, the device 100 according to an embodiment of the present invention enables developers or users to write hot patch codes without effort to understand the kernel space.

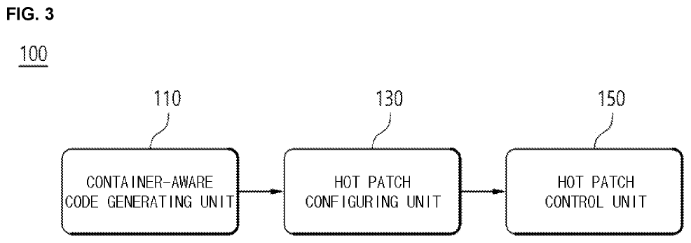

A specific configuration of the device 100 will be described in more detail in FIGS. 3 to 8 to be described later.

In FIG. 2, a dotted line arrow (Before patch) denotes a call flow of a container when a vulnerable kernel function is called before patching.

In FIG. 2, a solid line arrow (After patch) denotes a call flow of a container when a vulnerable kernel function is called after the hot patch is attached through the device 100.

As can be seen from FIG. 2, the system 10 of the present invention can dynamically patch kernel vulnerabilities by hooking before and after the call of a kernel function by using an eBPF-based hot patch code.

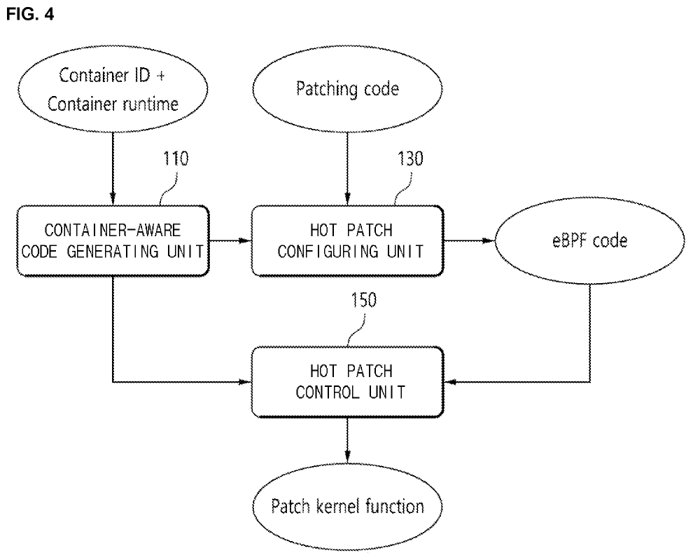

Meanwhile, FIGS. 3 and 4 are diagrams for describing an eBPF-based hot patch engine device 100 according to an embodiment of the present invention.

The device 100 does not require a reboot, and at the same time, can configure a hot patch code that does not affect the running container system 200.

In addition, the device 100 may allow the configured hot patch code to be patched only to a target container for hot patch attachment.

To this end, the device 100 may comprise a container-aware code-generating unit 110, a hot patch configuring unit 130, and a hot patch control unit 150.

The container-aware code generating unit 110 may generate a container-aware code for identifying a target container, to which the hot patch is attached.

Also, the container-aware code generating unit 110 may generate a container-aware code based on container information included in the container system 200.

Here, the container information may include at least one of container ID and container runtime information included in the container system 200, as shown in FIG. 4.

Specifically, the container ID may include the name and hash of the corresponding container, and runtime information of the container may be, for example, docker, containerd, and the like.

Also, the container-aware code generating unit 110 may calculate a mount namespace ID and a cGroup ID based on the container ID and runtime information.

Each ID is used to control container isolation, and is one of the important mechanisms of Linux container technology.

The container-aware code generating unit 110 calculates the mount namespace ID and cGroup ID because the concept of a container is made to make a process independent from a user space, and this concept does not exist in the kernel space.

That is, the isolation of containers is based on namespace IDs, which are assigned to one process or its child processes. Accordingly, the container-aware code generating unit 110 of the present invention may allow the mount namespace ID to be included in the container-aware code.

In addition, MAC (Mandatory Access Control) or other mechanisms such as SELinux or Apparmor, which are a kind of security policy enforcement, can be used to control the permission of process inside the container. Accordingly, the container-aware code generating unit 110 of the present invention may use information such as AppArmor info, cGroup ID, or SELinux info in the kernel space for container-aware, but this may be optional.

On the other hand, since the namespace ID is unique information that cannot be replaced, the container-aware code generating unit 110 necessarily includes the mount namespace in the container-aware code generating unit 110.

In addition, the container-aware code generating unit 110 may transfer the container-aware code to the hot patch configuring unit 130.

Meanwhile, the hot patch configuring unit 130 may configure an eBPF-based hot patch code (eBPF code) for attaching a hot patch to a target container based on the container-aware code.

A Berkeley Packet Filter (BPF) is a technology used in a specific computer operating system, and is particularly used in a program for network traffic analysis.

This BPF provides a raw interface to the data link layer so that raw packets of the link layer can be transmitted and received. Therefore, since BPF supports packet filtering, it is possible to provide a filter program that designates packets that user space processes want to receive.

For example, the tcpdump process might only want to receive packets initiating TCP connections.

And, the BPF can only return packets that pass the filter provided by the process, which can significantly improve performance by not copying unwanted packets from the operating system kernel to the process.

Meanwhile, eBPF (Linux Kernel's Extended BPF JIT Virtual Machine) is an innovative technology originating from the Linux kernel capable of executing sandboxed programs in the operating system kernel.

These eBPFs are used to safely and efficiently extend kernel functions without changing kernel source codes or loading kernel modules.

Also, popular kernel vulnerabilities, CVEs (Common Vulnerabilities and Exposures), are increasingly being used to exploit vulnerabilities.

To respond to attacks exploiting these vulnerabilities, a new version of the kernel should be patched, but a cloud system that should provide stable services may not be able to perform updates in a timely manner.

Conventional firewalls or access control solutions are temporary and highly likely to be bypassed, as the solutions act only when needed. Therefore, patches for known vulnerabilities assigned CVE numbers are required.

Accordingly, the hot patch configuring unit 130 of the present invention may configure an eBPF-based hot patch code (eBPF code) so that a patching code for CVE (Common Vulnerabilities and Exposures), which is a kernel vulnerability, can be patched to the kernel space used by the target container.

Here, the patching code may mean an actual patching code known by a system administrator or the Linux Foundation.

Also, the hot patch configuring unit 130 may load a preset hot patch template. The hot patch template of the present invention may be a reusable and intuitive template for allowing developers or users to write a hot patch code (eBPF code) without effort to understand the kernel space.

An eBPF-based hot patch code (eBPF code) may be configured by allowing information included in a patching code and a container-aware code to be input into the hot patch template.

The hot patch configuring unit 130 may configure a hot patch code (eBPF code) written in C language based on the above-described actual patching code.

Through this, the hot patch configuring unit 130 can configure a hot patch code (eBPF code), which is a complete eBPF code capable of attaching actual patching codes for multiple CVEs to the kernel space.

And, the hot patch configuring unit 130 may transfer the eBPF-based hot patch code (eBPF code) to the hot patch control unit 150.

Meanwhile, the hot patch control unit 150 may patch the hot patch code (eBPF code) to the kernel space used by the target container by using the BPF system call.

In addition, the hot patch control unit 150 may receive a notification when a vulnerability of the patched hot patch code (eBPF code) is triggered.

Accordingly, the device 100 according to the present invention can allow the hot patch code (eBPF code) to be individually patched only in the target container using the corresponding kernel space, and the entire container system 200 to be executable.

Accordingly, the device 100 according to the present invention can prevent an attack based on a CVE, which is a known vulnerability of the container system 200, by hot patching the CVE related to the kernel at runtime without rebooting and freezing.

Also, the device 100 can allow a plurality of patches to be independently applied to individual containers or multiple containers, rather than the entire container system.

In addition, the device 100 can allow a host or container system, in which a service runs, to be properly operated without interfering with them by patching using eBPF technology.

Hereinafter, a specific example of a process of configuring a hot patch code (eBPF code) using an actual patching code in the device 100 of the present invention will be described.

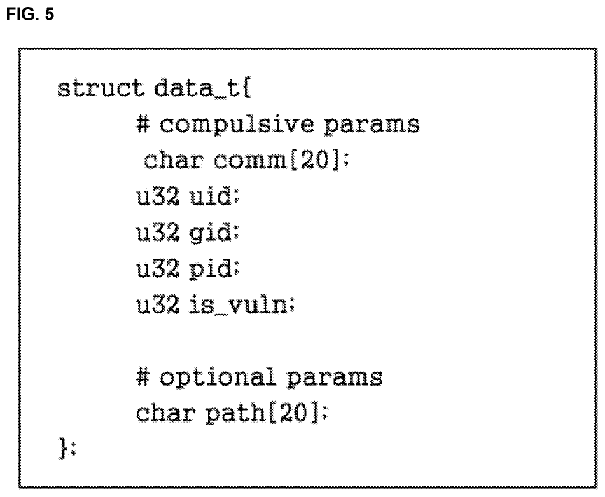

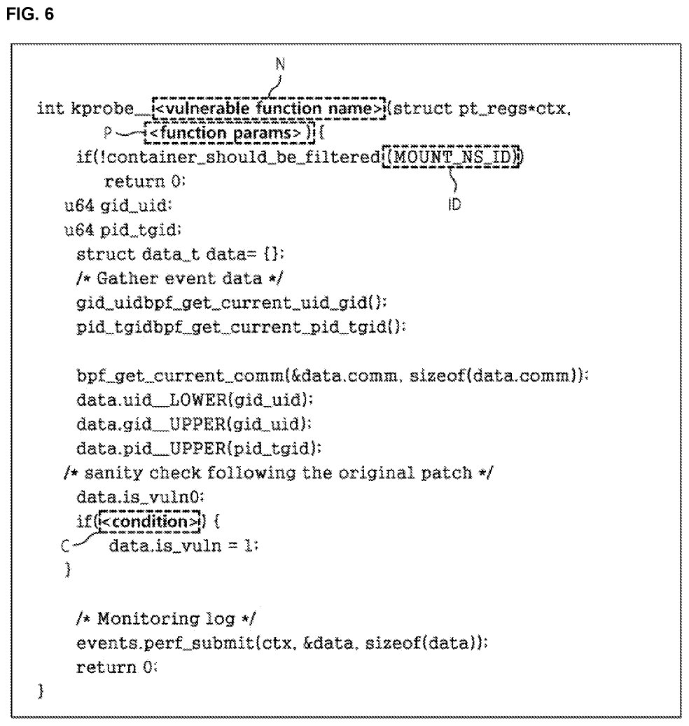

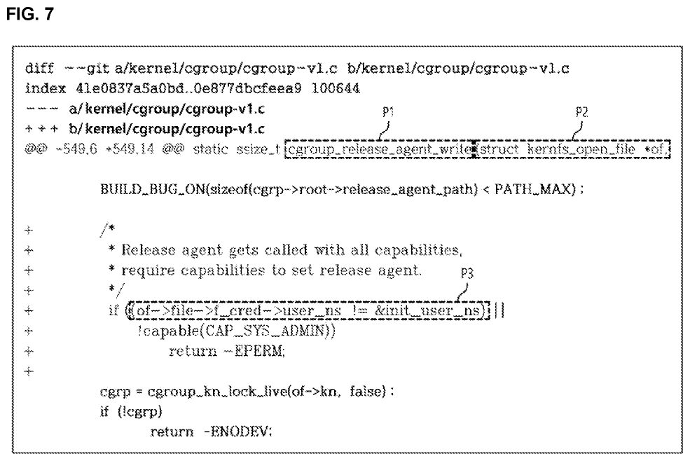

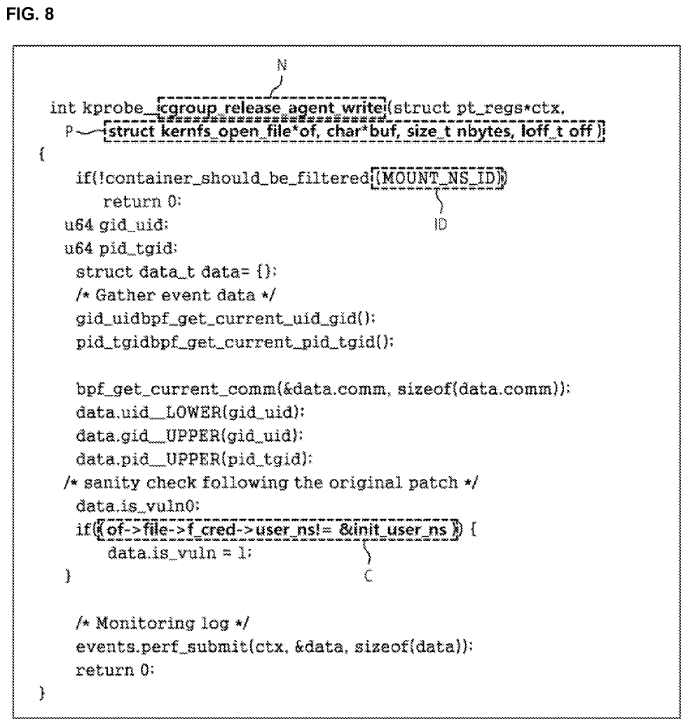

FIG. 5 is a diagram for describing parameters used in the eBPF-based hot patch engine device 100 according to an embodiment of the present invention, FIG. 6 is a diagram for describing a hot patch template used in the eBPF-based hot patch engine device 100 according to an embodiment of the present invention, FIG. 7 is a diagram for describing an actual patching code used to configure an eBPF code in the eBPF-based hot patch engine device 100 according to an embodiment of the present invention, and FIG. FIG. 8 is a diagram describing a process of configuring a hot patch code (eBPF) to solve the CVE of FIG. 7 in the eBPF-based hot patch engine device 100 according to an embodiment of the present invention.

Since the device 100 of the present invention and the system 10 including the device 100 have the eBPF system activated by default from kernel version 5.7×, it may be desirable to use kernel version 5.7× or higher.

Also, the hot patch template of the present invention may be a reusable and intuitive template for enabling developers or users to write a hot patch code (eBPF code) without effort to understand the kernel space.

However, to use the system 10 including the device 100 of the present invention, a system administrator is required to have basic knowledge about application security, such as how a specific CVE is patched.

Accordingly, the hot patch code (eBPF code) can be written in the same C language as the Linux kernel as described above, and the hot patch configuring unit 130 and the hot patch control unit 150 can automatically compile this hot patch code (eBPF code).

Therefore, an administrator or a user can use the system 10 including the device 100 of the present invention without worrying about the process of compiling at a low level.

In addition, the developer can define a list of libraries related to vulnerable functions that require patching and necessary parameters for information to be logged.

Specifically, for example, in the <Dependency libraries> part of the hot patch template, the developer needs to define a list of libraries related to vulnerable functions that require a patch. For example, the following libraries can be defined.
#include <linux/cgroup.h>
#include <trace/events/cgroup.h>
#include <linux/cgroupstats.h>

In addition, the developer can define parameters required for the information to be logged, which should be input into the struct data part, which is the <eBPF perf data structure> part in the hot patch template. For example, the parameters required for information to be logged may be as shown in FIG. 5.

More specifically, the eBPF perf data structure shown in FIG. 5 can be used for struct data_t data={ }; of the 8th line in the hot patch template shown in FIG. 8.

FIG. 6 is a specific example of a hot patch template used by the hot patch configuring unit 130 to configure a hot patch code. As shown in FIG. 6, the hot patch configuring unit 130 of the present invention can modify the <patching function> part of the hot patch template.

Specifically, the hot patch configuring unit 130 may configure a hot patch code (eBPF code) by modifying the loaded hot patch template according to an actual patching code for a specific vulnerability announced in Linux Kernel git.

For example, referring to FIG. 6, a region (N), in which a name of a patching function is input, may be included in the hot patch template.

In addition, the hot patch template may include a region (P), in which parameters necessary for information to be logged are input.

In addition, the hot patch template may include a region (ID), in which a target container is designated, and a region (C), in which conditions for hooking are input.

Such regions (N, P, ID, C) in this hot patch template are parts that require modification to configure the hot patch code (eBPF code).

FIG. 7 is an example of an actual patching code, to which a CVE number is assigned used to configure a hot patch code (eBPF code), referring to CVE-2022-0492.

The CVE needs to modify the cgroup_release_agent_write function to fix the vulnerability. And the actual patching code using sanity check is shown in FIG. 8.

In FIG. 7, the P1 region (P1) is a function name, the P2 region (P2) is a parameter required for information to be logged, and the P3 region (P3) is a condition, and the vulnerability can be addressed through such parts.

Accordingly, the hot patch configuring unit 130 may configure a hot patch code by modifying the hot patch template of FIG. 6 as shown in FIG. 8 based on the actual patching code, to which the CVE number is assigned as shown in FIG. 7.

More specifically, the function name of the P1 region (P1) of FIG. 7 is input into the region (N) in FIG. 8, into which the name of the patching function is input.

Further, the parameters of the P2 region (P2) of FIG. 7 may be input into the region P, into which parameters necessary for the information to be logged are input.

A container-aware code including a mount namespace ID may be input into a region (ID), in which a target container is designated.

Further, the condition of the P3 region (P3) of FIG. 7 may be input into the region C, into which conditions for hooking are input.

Through this process, the hot patch configuring unit 130 configures an eBPF-based hot patch code (eBPF code) so that the patching code for the kernel vulnerability, CVE, can be patched in the kernel space used by the target container.

The hot patch control unit 150 may attach the hot patch code (eBPF code) configured in this way to the kernel space using the BPF system call.

After the hot patch code (eBPF code) is attached, the system 10 including the device 100 can track the vulnerable function declared in the attached hot patch code (eBPF code). And the system 10 can determine if a vulnerability is triggered.

As described above, since the device 100 writes an eBPF-based hot patch code using the hot patch template and the sanity check of the actual patching code announced in Linux Kernel git, the sanity check can be guaranteed.

And, whenever a vulnerability is triggered, the eBPF program in the kernel space can send a notification to the hot patch control unit.

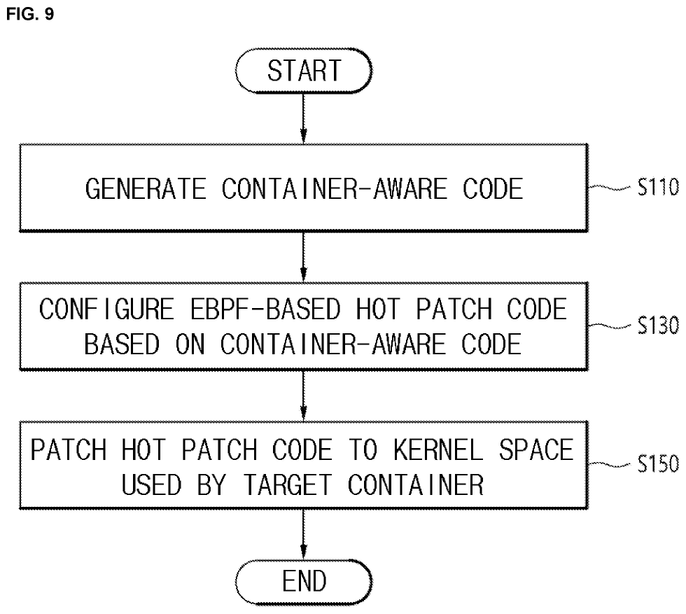

FIG. 9 is a flowchart illustrating an eBPF-based hot-patch method in the eBPF-based hot-patch engine device 100 of FIGS. 3 and 4. Since the eBPF-based hot patch method according to an embodiment of the present invention proceeds on substantially the same configuration as the device 100 shown in FIGS. 1 to 4 and the system 10 including the device 100, the same reference numerals are given to the same components as the device 100 shown in FIGS. 1 to 4 and the system 10 including the device 100, and repeated descriptions will be omitted.

The eBPF-based hot patch method in the eBPF-based hot-patch engine device 100 for protecting kernel vulnerabilities of the present invention may comprise generating a container-aware code (S110), configuring an eBPF-based hot patch code (S130) and patching the hot patch code to a kernel space used by a target container (S150).

In the step of generating the container-aware code (S110), the container-aware code generating unit 110 may generate a container-aware code for identifying a target container, to which the hot patch is attached.

In the step of generating the container-aware code (S110), the container-aware code may be generated based on the container information included in the container system 200.

Here, the information about the container may include at least one of container ID and runtime information of the container included in the container system 200. And, the container ID may include the name and hash of the corresponding container.

Therefore, the container-aware code may include a mount namespace ID.

Meanwhile, in the step of configuring the hot patch code (S130), the hot patch configuring unit 130 may configure an eBPF-based hot patch code to attach the hot patch to the target container based on the container-aware code.

At this time, in the step of configuring the hot patch code (S130), the hot patch configuration unit 130 may configure an eBPF-based hot patch code so that the patching code for CVE (Common Vulnerabilities and Exposures), which is a kernel vulnerability, can be patched to the kernel space used by the target container.

Also, in the step of configuring the hot patch code (S130), a preset hot patch template may be loaded to configure the hot patch code (eBPF code).

Further, in the step of configuring the hot patch code (S130), an eBPF-based hot patch code may be configured by inputting information included in the patching code for the CVE and the container-aware code to the loaded hot patch template.

Meanwhile, in the step of patching the hot patch code (eBPF code) to the kernel space used by the target container (S150), the hot patch code configured in the step of configuring the hot patch code (S130) can be patched to the kernel space.

This allows, once the hot patch code is patched, to track the vulnerable function declared in the hot patch code to check if the vulnerability is triggered.

And in the step of patching the hot patch code (eBPF code) to the kernel space used by the target container (S150), when the vulnerability of the patched hot patch code is triggered after the hot patch code is patched, a notification can be received from the eBPF program in the kernel space.

Through this, the eBPF-based hot patch method according to an embodiment of the present invention allows hot patch codes to be individually patched only in target containers using the corresponding kernel space, and the container system 200 to be executable.

Such an eBPF-based hot patch method of the present invention may be implemented in the form of program instructions that can be executed through various computer components and recorded on a computer-readable recording medium. The computer-readable recording medium may include program instructions, data files, data structures, etc. alone or in combination.

Program instructions recorded on the computer-readable recording medium may be specially designed and configured for the present invention, or may be known and usable to those skilled in the art of computer software.

Examples of computer-readable recording media include magnetic media such as hard disks, floppy disks and magnetic tapes, optical recording media such as CD-ROMs and DVDs, magneto-optical media such as floptical disks, and hardware devices specially configured to store and execute program instructions, such as ROM, RAM, flash memory, and the like.

Examples of program instructions include high-level language codes that can be executed by a computer using an interpreter as well as machine language codes such as those produced by a compiler. The hardware device may be configured to act as one or more software modules to perform processing according to the present invention and vice versa.

Although various embodiments of the present invention have been shown and described above, the present invention is not limited to the specific embodiments described above, and various modifications can be made by those skilled in the art to which the present invention pertains without departing from the gist of the present invention claimed in the claims. And, these modifications should not be individually understood from the technical spirit or prospect of the present invention.

### REFERENCE NUMERAL

10: eBPF-based hot patch system
100: eBPF-based hot patch engine device
110: container-aware code generating unit
130: hot patch configuring unit
150: hot patch control unit
200: container system

1. An eBPF-based hot patch engine device for protecting kernel vulnerabilities comprising:
a container-aware code generating unit for generating a container-aware code for identifying a target container, to which a hot patch is attached; and
a hot patch configuring unit for configuring an eBPF-based hot patch code for attaching a hot patch to the target container based on the container-aware code.

2. The device of claim 1, wherein the hot patch configuring unit configures an eBPF-based hot patch code so that a patching code for CVE (Common Vulnerabilities and Exposures), which is a kernel vulnerability, can be patched to a kernel space used by the target container.

3. The device of claim 2, wherein the container-aware code generating unit generates the container-aware code based on container information included in a container system,
wherein the container information includes at least one of a container ID and container runtime information included in the container system.

4. The device of claim 3, wherein the container ID includes a name and hash of a corresponding container.

5. The device of claim 2, wherein the hot patch configuring unit configures the eBPF-based hot patch code by loading a preset hot patch template and inputting information included in the patching code and the container-aware code into the hot patch template.

6. The device of claim 2 further comprises,
a hot patch control unit for patching the hot patch code to a kernel space used by the target container using a BPF system call and receiving a notification when a vulnerability of the patched hot patch code is triggered.

7. The device of claim 6, wherein the device allows the hot patch code to be individually patched only in the target container using a corresponding kernel space, and a container system to be executable.

8. The device of claim 1, wherein the container-aware code includes a mount namespace ID.

9. An eBPF-based hot patch method in an eBPF-based hot patch engine device for protecting kernel vulnerabilities comprising:
generating a container-aware code for identifying a target container, to which a hot patch is attached; and
configuring an eBPF-based hot patch code for attaching a hot patch to the target container based on the container-aware code.

10. The method of claim 9, wherein configuring the eBPF-based hot patch code comprises configuring the eBPF-based hot patch code so that a patching code for CVE (Common Vulnerabilities and Exposures), which is a kernel vulnerability, can be patched to a kernel space used by the target container.

11. The method of claim 10, wherein generating the container-aware code comprises generating the container-aware code based on container information included in a container system,
wherein the container information includes at least one of a container ID and container runtime information included in the container system.

12. The method of claim 11, wherein the container ID includes a name and hash of a corresponding container.

13. The method of claim 10, wherein configuring the eBPF-based hot patch code comprises configuring the eBPF-based hot patch code by loading a preset hot patch template and inputting information included in the patching code and the container-aware code into the hot patch template.

14. The method of claim 10 further comprises,
patching the hot patch code to a kernel space used by the target container and receiving a notification when a vulnerability of the patched hot patch code is triggered.

15. The method of claim 14, wherein the hot patch code is individually patched only in the target container using a corresponding kernel space, and a container system is executable.

16. The method of claim 9, wherein the container-aware code includes a mount namespace ID.

17. A container system including at least one container comprising:
an eBPF-based hot patch engine device for protecting kernel vulnerabilities,
wherein the eBPF-based hot patch engine device generates a container-aware code for identifying a target container, to which a hot patch is attached, in the container system, configures an eBPF-based hot patch code based on the container-aware code, and patches the hot patch code to a kernel space used by the target container.

18. The system of claim 17, wherein the eBPF-based hot patch engine device comprises,
a container-aware code generating unit for generating a container-aware code for identifying a target container, to which a hot patch is attached;
a hot patch configuring unit for configuring an eBPF-based hot patch code for attaching a hot patch to the target container based on the container-aware code; and
a hot patch control unit for patching the hot patch code to a kernel space using a BPF system call and receiving a notification when a vulnerability of the patched hot patch code is triggered.
